(19) United States
(12) Patent Application Publication
(10) Pub. No.: US 2026/0179454 A1
(43) Pub. Date: Jun. 25, 2026

(54) HANDLING CAPPING IN A GAMING ENVIRONMENT

(71) Applicant: IGT, Las Vegas, NV (US)

(72) Inventors: Sylvie ROUSSEL, Moncton (CA); Richard SAVOIE, Moncton (CA); Dwayne NELSON, Las Vegas, NV (US)

(73) Assignee: IGT, Las Vegas, NV (US)

(21) Appl. No.: 18/988,588

(22) Filed: Dec. 19, 2024

(51) Int. Cl. G07F 17/32

(52) U.S. Cl. CPC G07F 17/3267; G07F 17/323; G07F 17/3244

(57) ABSTRACT

A system includes a processor circuit and a memory comprising machine-readable instructions that, when executed by the processor circuit, cause the processor circuit to provide methods for handling capping in a gaming environment. Such methods receiving a wager input that corresponds to a wager of a game to process on a gaming terminal, receiving a player input that causes the gaming terminal to execute the wager, determining an outcome corresponding to the wager, based on the outcome corresponding to a winning outcome, determining that a winning amount causes a total win amount to exceed a maximum allowed winning outcome, in response to the total win amount exceeding the maximum allowed winning outcome, canceling the total win amount that exceeds the maximum allowed winning outcome, and providing a non in-game compensation for a canceled winning amount.

### BACKGROUND

In the gaming industry, each jurisdiction has its own regulations and requirements. Some of those jurisdictions do not allow wins to be capped. Capping a win means truncating a win amount so that it does not exceed a maximum allowable value of the jurisdiction. Such limits on a gaming player may result in frustration for a player with a capped score or award. Thus, a manner of reducing capping impact related frustration may be beneficial.

### BRIEF SUMMARY

A system includes a processor circuit and a memory includes machine-readable instructions that, when executed by the processor circuit, cause the processor circuit to perform operations. Such operations may include receiving a wager input that corresponds to a wager of a game to process on a gaming terminal and receiving a player input that causes the gaming terminal to execute the wager. Operations may include determining an outcome corresponding to the wager based on a first return to player (RTP) paytable. Operations include, based on the outcome corresponding to a winning outcome, determining that a winning amount causes a total win amount to exceed a maximum allowed winning outcome. Operations may include in response to the total win amount exceeding the maximum allowed, replacing the first RTP paytable with a second RTP paytable that is higher than the first RTP paytable on future executions of a future games.

An electronic gaming machine (EGM) includes a communication interface in communication with a plurality of gaming devices, a processor circuit and a memory including machine-readable instructions that, when executed by the processor circuit, cause the processor circuit to perform operations including receiving a wager input that corresponds to a wager of a game to process on a gaming terminal, receiving a player input that causes the gaming terminal to execute the wager. Operations may include determining an outcome corresponding to the wager based on a first return to player (RTP) paytable and, based on the outcome corresponding to a winning outcome, determining that a winning amount causes a total win amount to exceed a maximum allowed winning outcome. After determining that the winning amount causes the total win amount to exceed the maximum allowed winning outcome, the processor circuit is further caused to deposit max win amount in credit bank window. In response to the total win amount exceeding the maximum allowed, operations include replacing the first RTP paytable with a second RTP paytable that is higher than the first RTP paytable on future executions of a future games.

Methods are provided herein. A method may include receiving a wager input that corresponds to a wager of a game to process on a gaming terminal and receiving a player input that causes the gaming terminal to execute the wager. Operations may include determining an outcome corresponding to the wager based on a first return to player (RTP) paytable. Operations may include, based on the outcome corresponding to a winning outcome, determining that a winning amount causes a total win amount to exceed a maximum allowed winning outcome. Embodiments include, in response to the total win amount exceeding the maximum allowed, replacing the first RTP paytable with a second RTP paytable that is higher than the first RTP paytable on future executions of a future games.

Provided is a flowchart illustrating operations of systems/methods of providing capping handling in a gaming environment, according to some embodiments. A system herein may include a processor circuit and a memory including machine-readable instructions that, when executed by the processor circuit, cause the processor circuit to perform operation herein. Operations include receiving a wager input that corresponds to a wager of a game to process on a gaming terminal, receiving a player input that causes the gaming terminal to execute the wager and determining an outcome corresponding to the wager. Operations may further include, based on the outcome corresponding to a winning outcome, determining that a winning amount causes a total win amount to exceed a maximum allowed winning outcome. Operations include, in response to the total win amount exceeding the maximum allowed winning outcome, cancelling the total win amount that exceeds the maximum allowed winning outcome and providing a non in-game compensation for a canceled winning amount.

An electronic gaming machine (EGM) includes a communication interface in communication with a plurality of gaming devices, a processor circuit, and a memory including machine-readable instructions that, when executed by the processor circuit, cause the processor circuit to perform operations. Operations may include receiving a wager input that corresponds to a wager of a game to process on a gaming terminal and receiving a player input that causes the gaming terminal to execute the wager. Operations include determining an outcome corresponding to the wager and, based on the outcome corresponding to a winning outcome, determining that a winning amount causes a total win amount to exceed a maximum allowed winning outcome. Some embodiments include, in response to the total win amount exceeding the maximum allowed winning outcome, canceling the total win amount that exceeds the maximum allowed winning outcome that corresponds to a regulatory requirement imposed by a government entity.

A flowchart illustrating operations of systems/methods of providing capping handling in a gaming environment is provided. Methods herein perform operations including receiving a wager input that corresponds to a wager of a game to process on a gaming terminal and receiving a player input that causes the gaming terminal to execute the wager. Operations include determining an outcome corresponding to the wager and, based on the outcome corresponding to a winning outcome, determining that a winning amount causes a total win amount to exceed a maximum allowed winning outcome. Some embodiments provide that, in response to the total win amount exceeding the maximum allowed winning outcome, canceling the total win amount that exceeds the maximum allowed winning outcome and providing a non in-game compensation for a canceled winning amount.

### BRIEF DESCRIPTION OF SEVERAL VIEWS OF THE DRAWINGS

FIG. 1 is a schematic block diagram illustrating a network configuration for a plurality of gaming devices according to some embodiments.

FIG. 2A is a perspective view of a gaming device that can be configured according to some embodiments.

FIG. 2B is a schematic block diagram illustrating an electronic configuration for a gaming device according to some embodiments.

FIG. 2C is a schematic block diagram that illustrates various functional modules of a gaming device according to some embodiments.

FIG. 2D is a perspective view of a gaming device that can be configured according to some embodiments.

FIG. 2E is a perspective view of a gaming device according to further embodiments.

FIG. 3 is a schematic block diagram that illustrates handling capping in accordance with some embodiments.

FIG. 4 is a schematic block diagram that illustrates handling capping by adjusting paytables in accordance with some embodiments

FIG. 5 is a schematic block diagram that illustrates handling capping in accordance with some embodiments.

FIG. 6 is a schematic block diagram that illustrates handling capping in accordance with some embodiments.

FIG. 7 is a flowchart illustrating operations of systems/methods of providing capping handling in a gaming environment, according to some embodiments.

FIG. 8 is a flowchart illustrating operations of systems/methods of providing capping handling in a gaming environment, according to some embodiments.

FIG. 9 is a flowchart illustrating operations of systems/methods of providing capping handling in a gaming environment, according to some embodiments.

FIG. 10 is a flowchart illustrating operations of systems/methods of providing capping handling in a gaming environment, according to some embodiments.

FIG. 11 is a flowchart illustrating operations of systems/methods of providing capping handling in a gaming environment, according to some embodiments.

FIG. 12 is a flowchart illustrating operations of systems/methods of providing capping handling in a gaming environment, according to some embodiments.

### DETAILED DESCRIPTION

Embodiments described herein relate to gaming environments, and in particular to gaming operations that use capping to provide gambling limitations, and related devices, systems, and methods.

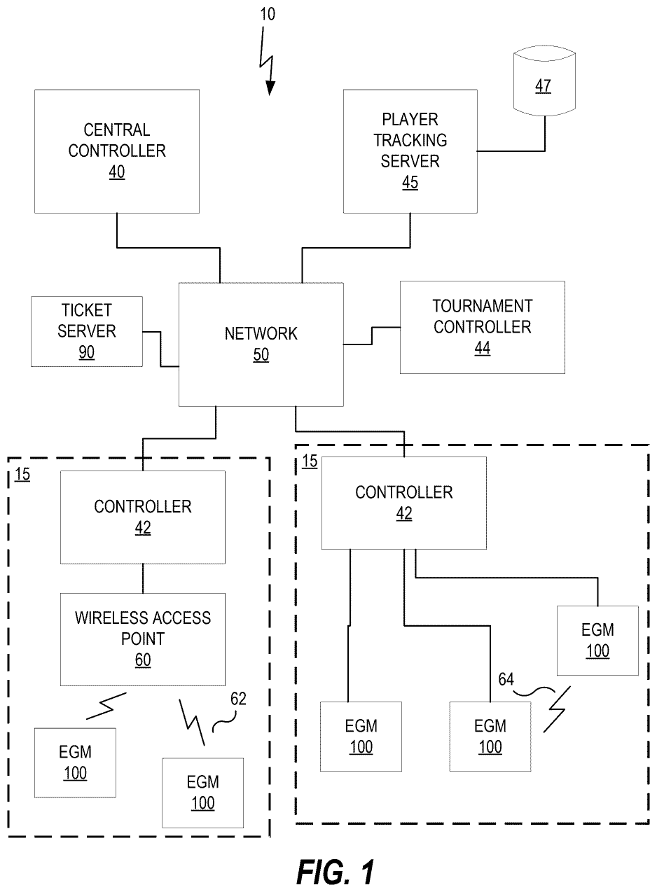

Before describing these and other features in greater detail, reference is now made to FIG. 1, which illustrates a gaming system 10 including a plurality of gaming devices 100 (which are EGMs in this embodiment). The gaming devices 100 may be one type of a variety of different types of gaming devices, such as electronic gaming machines (EGMs), video lottery terminals (VLTs), mobile gaming devices, or other devices, for example. The gaming system 10 may be located, for example, on the premises of a gaming establishment, such as a casino, and/or distributed across one or more different locations 15, such as a plurality of retailers or other establishments. The gaming devices 100 may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. Each location 15 may include a site controller 42 for managing communication with the central controller 40 and for controlling and managing the gaming devices 100. The central controller 40 and/or site controller 42 may be any suitable server or computing device which includes at least one processing circuit and at least one memory or storage device. Each gaming device 100 (which are EGMs in this example) may include a processing circuit that transmits and receives events, messages, commands or any other suitable data or signal between the gaming device 100, the site controller 42, and/or the central controller 40. The gaming device processing circuit is operable to execute such communicated events, messages or commands in conjunction with the operation of the gaming device 100. Moreover, the processing circuit of the and/or site controller 42 is configured to transmit and receive events, messages, commands or any other suitable data or signal between the central controller 40, the site controller 42, and/or each of the individual gaming devices 100. In some embodiments, one or more of the functions of the central controller 40 and/or site controller 42 may be performed by one or more gaming device processing circuits. Moreover, in some embodiments, one or more of the functions of one or more gaming device processing circuits as disclosed herein may be performed by the central controller 40 and/or site controller 42.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 and/or site controller 42 through the data communication network 50. The ticket server 90 may be located remotely from the individual locations 15 and/or site controllers 42 and/or may be located at individual locations 15 and/or proximate to individual site controllers 42. In some examples, the ticket server 90 and/or functions thereof may be integrated into the central controller 40 and/or local controllers 42. Each ticket server 90 may include a processing circuit that transmits and receives events, messages, commands or any other suitable data or signal between the ticket server 90 and the central controller 40 and/or local controller 42. The ticket server 90 processing circuit may be operable to execute such communicated events, messages or commands in conjunction with the operation of the ticket server 90. Moreover, in some embodiments, one or more of the functions of one or more ticket server 90 processing circuits as disclosed herein may be performed by the central controller 40 and/or local controller 42. In some embodiments, a tournament controller 44 may be in communication with the gaming devices 100 via one or more communication protocols.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, a near field communications (NFC) link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. Some embodiments provide that gaming devices 100 may communicate with other gaming devices 100 or other system components over a wireless interface 64. In these embodiments, wireless interface 62, and wireless interface 64 may use different communication protocols and/or different communication resources, such as different frequencies, time slots, spreading codes, etc.

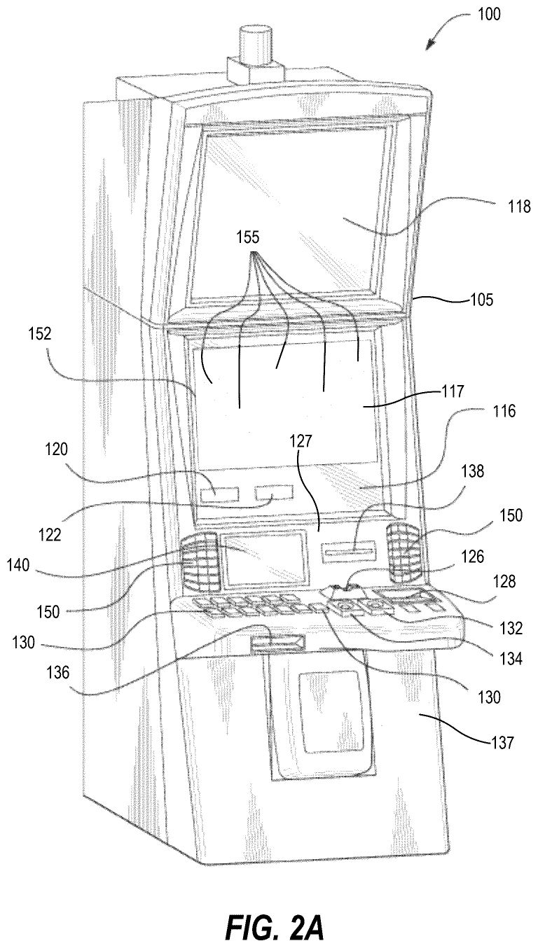

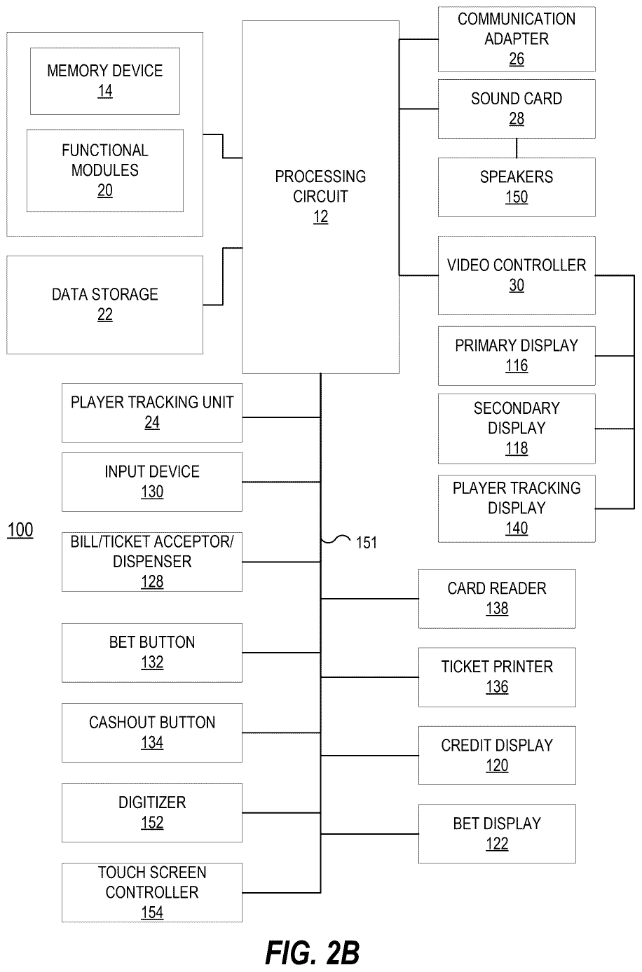

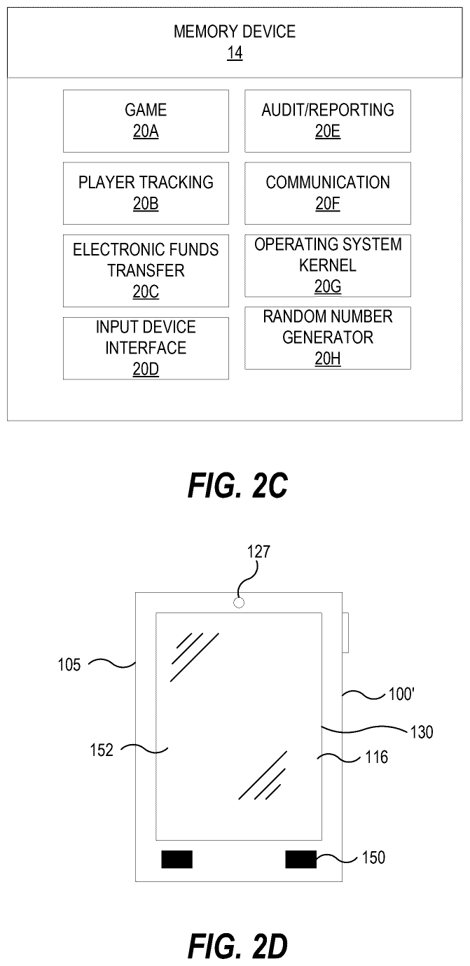

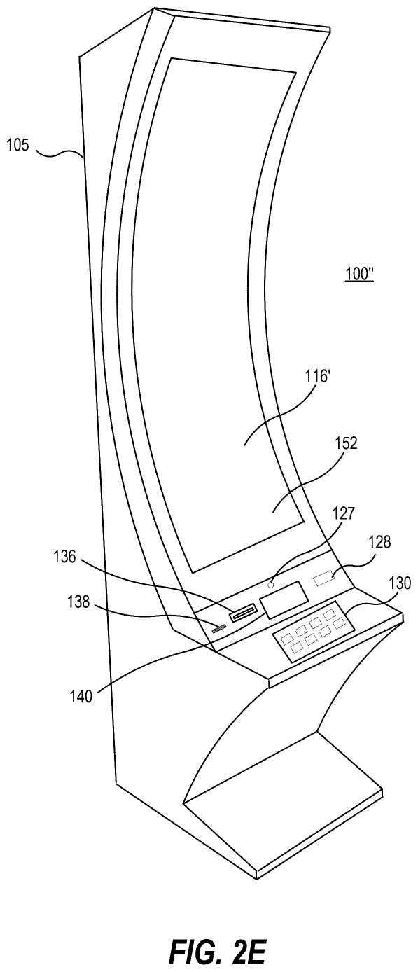

Embodiments herein may include different types of gaming devices. One example of a gaming device includes a gaming device 100 that can use gesture and/or touch-based inputs according to various embodiments is illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A to 2C are provided as examples for illustrative purposes only. It will be appreciated that gaming devices may come in many different shapes, sizes, layouts, form factors, and configurations, and with varying numbers and types of input and output devices, and that embodiments are not limited to the particular gaming device structures described herein.

Gaming devices 100 typically include a number of standard features, many of which are illustrated in FIGS. 2A and 2B. For example, referring to FIG. 2A, a gaming device 100 (which is an EGM 160 in this embodiment) may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 140, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 140 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 140, the credit display 120 and the bet display 122 may be displayed in one or more portions of one or more other displays that display other game related visual content. For example, one or more of the player tracking display 140, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as gesture sensors for gesture input devices, and/or a touch-sensitive display that includes a digitizer 152 and a touchscreen controller (154 at FIG. 2B) for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 140 may be controlled by a video controller 30 that receives video data from a processing circuit 12 or directly from a memory device 14 and displays the video data on the display screen. The credit display 120 and the bet display 122 are typically implemented as simple liquid crystal display (LCD) or light emitting diode (LED) displays that display a number of credits available for wagering and a number of credits being wagered on a particular game. Accordingly, the credit display 120 and the bet display 122 may be driven directly by the processing circuit 12. In some embodiments however, the credit display 120 and/or the bet display 122 may be driven by the video controller 30.

Referring again to FIG. 2A, the display devices 116, 118, 140 may include, without limitation: a cathode ray tube, a plasma display, an LCD, a display based on LEDs, a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket dispenser 136, a bill/ticket acceptor 128, and a coin acceptor 126 that allows the player to deposit coins into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processing circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processing circuit 12 that controls operations of the gaming device 100. Although illustrated as a single processing circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processing circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processing circuit 12. It will be appreciated that the components may be connected to the processing circuit 12 through a system bus 151, a communication bus and controller, such as a universal serial bus (USB) controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2C.

The memory device 14 may store program code and instructions, executable by the processing circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, Digital Video Disc (“DVD”) or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or NFC that enable the gaming device 100 to communicate, for example, with a mobile communication device operated by a player.

The gaming device 100 may include one or more internal or external communication ports that enable the processing circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, Small Computer System Interface (“SCSI”) ports, solenoids, speakers, thumb drives, ticket readers, touch screens, trackballs, touchpads, wheels, and wireless communication devices. In some embodiments, internal or external peripheral devices may communicate with the processing circuit through a USB hub (not shown) connected to the processing circuit 12.

In some embodiments, the gaming device 100 may include a sensor, such as a camera 127, in communication with the processing circuit 12 (and possibly controlled by the processing circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processing circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

In some embodiments, a gaming device 100 includes a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

For example, referring to FIG. 2D, a gaming device 100 (which is a mobile gaming device 170 in this embodiment) may be implemented as a handheld device including a compact housing 105 on which is mounted a touchscreen display device 116 including a digitizer 152. One or more input devices 130 may be included for providing functionality of for embodiments described herein. A camera 127 may be provided in a front face of the housing 105. The housing 105 may include one or more speakers 150. In the gaming device 100, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100 may omit certain features, such as a bill acceptor, a ticket generator, a coin acceptor or dispenser, a card reader, secondary displays, a bet display, a credit display, etc. Credits can be deposited in or transferred from the gaming device 100 electronically.

FIG. 2E illustrates a standalone gaming device 100 (which is an EGM 160 in this embodiment) having a different form factor from the EGM 160 illustrated in FIG. 2A. In particular, the gaming device 100 is characterized by having a large, high aspect ratio, curved primary display device 116 provided in the housing 105, with no secondary display device. The primary display device 116 may include a digitizer 152 to allow touchscreen interaction with the primary display device 116. The gaming device 100 may further include a player tracking display 140, an input device 130, a bill/ticket acceptor 128, a card reader 138, and a bill/ticket dispenser 136. The gaming device 100 may further include one or more cameras 127 to enable facial recognition and/or motion tracking.

Embodiments herein may include different types of gaming devices.

Many embodiments described herein employ gaming devices 100 that are land-based EGMs, such as banks of slot machines in a casino environment, but in some embodiments, a gaming device 100 may additionally or alternatively include a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

Although illustrated as certain gaming devices, such as EGMs, VLTs, and mobile gaming devices, functions and/or operations as described herein may also include wagering stations that may include electronic game tables, conventional game tables including those involving cards, dice and/or roulette, and/or other wagering stations such as sports book stations, video poker games, skill-based games, virtual casino-style table games, or other casino, lottery, or other style games. Further, gaming devices according to embodiments herein may be implemented using other computing devices and mobile devices, such as smart phones, tablets, and/or personal computers, among others.

In some example embodiments, if a jurisdiction's maximum allowable win amount is set at $2,500 per spin and if the sum of all coinciding wins on a particular screen adds up to $2,600, the player may only be awarded $2,500 (and the additional $100 amount will be lost to the player). As disclosed herein, there are ways to compensate the player for those losses when capping scenarios occur. For example, the game may have the game switch to a higher RTP paytable for a predefined number of games. In some embodiments, an award of a quantity of free games at a certain wager for which the total wager amount of those spins that add up to the credits lost.

In some of our video lottery terminal (VLT) jurisdictions, it may be allowed to cap and/or truncate wins based on the maximum win amount of the jurisdiction. For example, if the maximum allowable win in a market that allows truncation is $1,000, it means that if all wins on screen add up to $1500, $500 is lost to the player and kept by the operator. This may reduce the RTP experience for the player. In some embodiments, something may be given back to the player in a form other than credits/money.

In some embodiments, a point system provides that a given quantity of amount of capped credit is equivalent to different points on your card. Once you reach a certain threshold of points, you may be awarded either merchandise or a ballot for draw. In some embodiments, it may be in the form of a lottery ticket, such as a second chance type of lottery ticket. Some embodiments provide that the player may log into a website in which points may be used to redeem items. Such embodiments may add a positive note for the player whose win has just been capped.

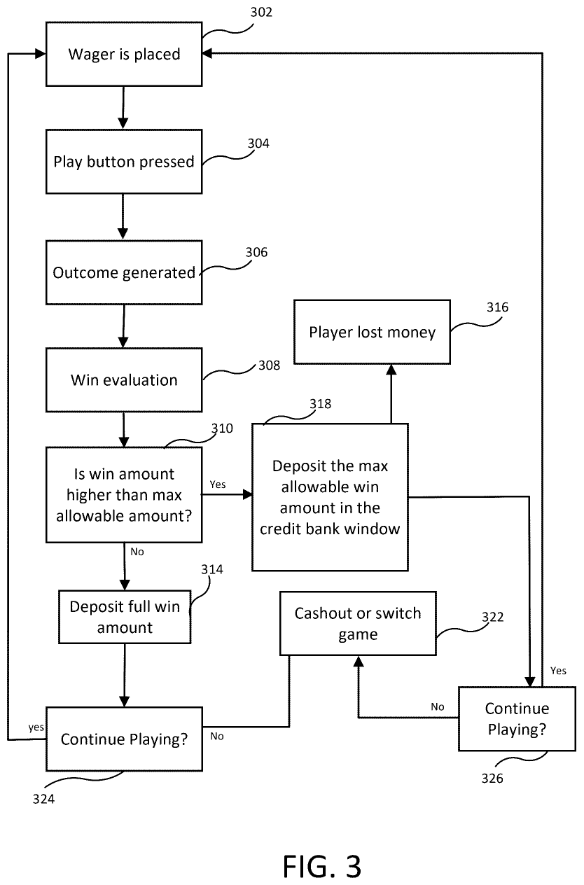

Brief reference is now made to FIG. 3, which is a schematic block diagram that illustrates handling capping in accordance with some embodiments. A wager is placed (block 302), a play button is pressed (block 304), an outcome is generated (block 306) and a win evaluation (block 308) is performed.

It is determined (block 310) as to whether the win amount is higher than a maximum allowable amount. If the win amount is higher than the max allowable amount then deposit the max allowable win amount in the credit bank window (block 318) and the player lost money (block 316). The player may continue playing (block 324, 326). If the win amount is not higher than the max allowable amount the deposit the full win amount (block 314).

In some examples, a 92% paytable may be used as a base paytable of the game. However, such number is non-limiting as the paytable may be more or less than 92%. In such embodiments, when a capping scenario occurs, the game may switch to a higher paytable. For example, several higher RTP paytables could be available including those ranging from 94%-97%, among others. In some embodiments, one paytable may be selected based on one criteria and on and one paytable could be selected based on multiple factors. Such factors include a random selection between all higher paytables (could be a weighted draw), the amount of credits that were lost. For example, if 50-250 credits were truncated and lost then switch to a 94% paytable; if 251-500 credits were truncated and lost then switch to a 95% paytable; if 501-750 credits were truncated and lost then switch to a 96% paytable; and if more than 750 credits were truncated and lost then switch to a 97% paytable.

In some embodiments, this paytable may remain in play for a specific number of games. The games could be free or require a wager. The amount of games awarded at this updated paytable could be selected based on: random selection in a range of 5-15 games being awarded.) If the example credits provide that: 50-250 credits were truncated and lost then award 5 games at the higher paytable; 251-500 credits were truncated and lost then award 8 games at the higher paytable; 501-750 credits were truncated and lost then award 12 games at the higher paytable; and if greater than 750 credits were truncated and lost then award 15 games at the higher paytable.

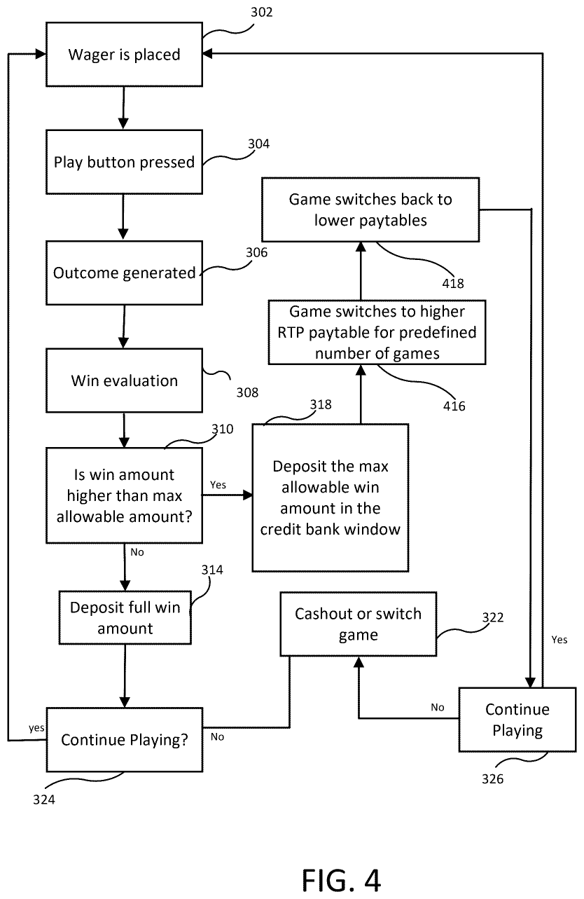

Brief reference is now made to FIG. 4, which is a schematic block diagram that illustrates handling capping by adjusting paytables in accordance with some embodiments. A wager is placed (block 302), a play button is pressed (block 304), an outcome is generated (block 306) and a win evaluation (block 308) is performed.

It is determined (block 310) as to whether the win amount is higher than a maximum allowable amount. If the win amount is higher than the max allowable amount then deposit the max allowable win amount in the credit bank window (block 318). Once the max allowable deposit is made, the game switches to a higher RTP paytable for a predefined number of games (block 416). In some embodiments, the higher RTP may be played for a given period of time, until a given amount is won or after a given event is hit. For example, the capping may make the “lose” $100 so the system may enable the higher paytable until the player can win the $100 and/or won ana additional $100 due to the new paytable. In some embodiments, we may enable the higher RTP until the player has one or more bonuses of game features.

Additionally, the game switches back to the lower paytables (block 418) after the predefined games have been played at the lower RTP paytable. The player may continue playing (block 324, 326). If the win amount is not higher than the max allowable amount the deposit the full win amount (block 314).

In some embodiments, when a capping scenario occurs, the credits that were lost may be used as wagers for a predefined number of games. For example, if the Maximum Allowable Win is $2,500 and the sum of all coinciding wins on a particular outcome add up to $2,600, the player is only awarded $2,500 but the next 20 spins are free at $5 per spin. The $100 that was lost due to capping is given back through free play.

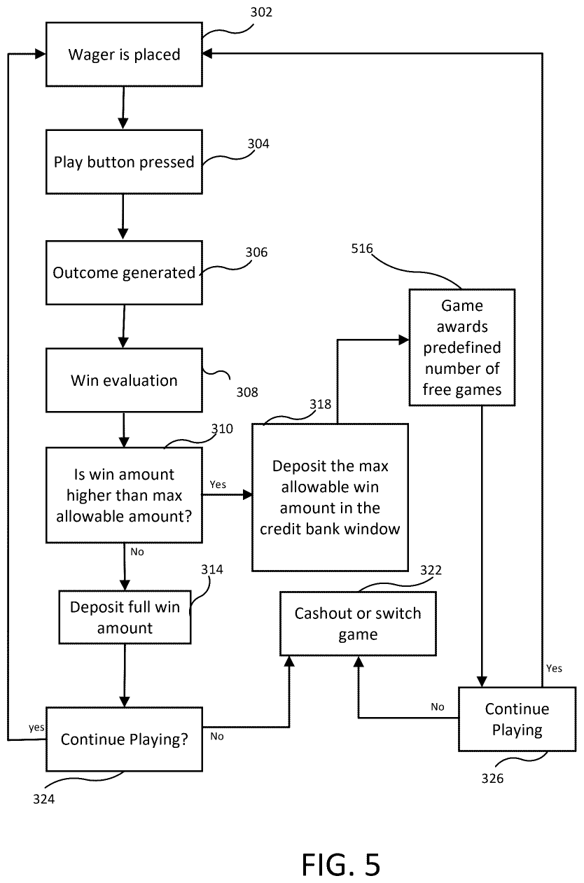

Brief reference is now made to FIG. 5, which is a schematic block diagram that illustrates handling capping in accordance with some embodiments. A wager is placed (block 302), a play button is pressed (block 304), an outcome is generated (block 306) and a win evaluation (block 308) is performed.

It is determined (block 310) as to whether the win amount is higher than a maximum allowable amount. If the win amount is higher than the max allowable amount then deposit the max allowable win amount in the credit bank window (block 318). Once the max allowable deposit is made, game awards including a predefined number of free games may be provided (block 516).

Some embodiments may provide that the player may be compensated based on features or enhancements that are not be in-game features or enhancements. For example, options may provide that the player is awarded a service, meal, discount, coupon, drink, massage, etc. At the moment of the capping, the system could dispatch a person to bring the player a drink or provide a coupon for a service at the casino. In some embodiments, at the moment of capping, a window may pop up to inform the players how they are being compensated. Such message may have the player play a game or spin a wheel to win merchandise and/or be informed where they can pick up their award/merchandise.

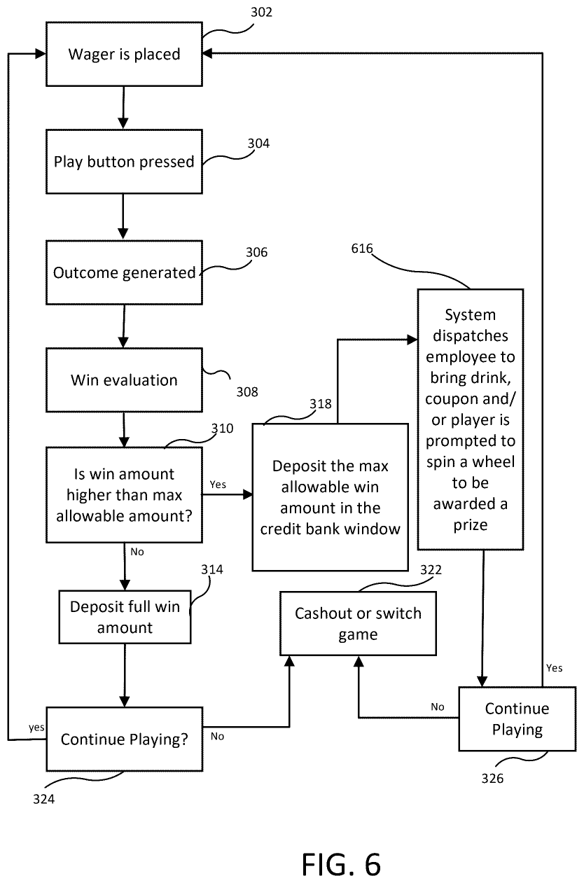

Brief reference is now made to FIG. 6, which is a schematic block diagram that illustrates handling capping in accordance with some embodiments. A wager is placed (block 302), a play button is pressed (block 304), an outcome is generated (block 306) and a win evaluation (block 308) is performed.

It is determined (block 310) as to whether the win amount is higher than a maximum allowable amount. If the win amount is higher than the max allowable amount then deposit the max allowable win amount in the credit bank window (block 318). Once the max allowable deposit is made, the system may dispatch an employee (block 616) to offer a drink, coupon, etc., and/or a player may be prompted to spin a wheel to be awarded a prize.

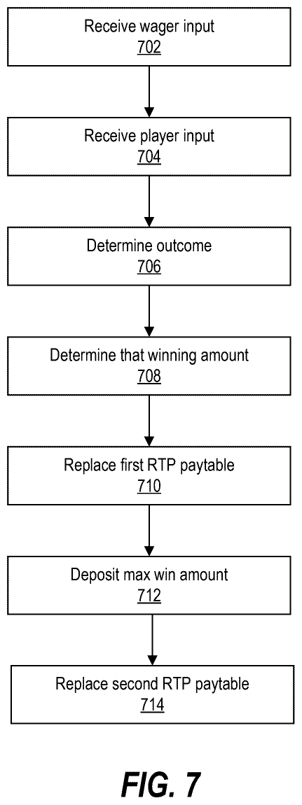

Reference is now made to FIG. 7, which is a flowchart illustrating operations of systems/methods of providing capping handling in a gaming environment, according to some embodiments. A system may include a processor circuit and a memory include machine-readable instructions that, when executed by the processor circuit, cause the processor circuit to perform operations. Such operations may include receiving (block 702) a wager input that corresponds to a wager of a game to process on a gaming terminal and receiving (block 704) a player input that causes the gaming terminal to execute the wager. Operations may include determining (block 706) an outcome corresponding to the wager based on a first return to player (RTP) paytable. Operations include, based on the outcome corresponding to a winning outcome, determining (block 708) that a winning amount causes a total win amount to exceed a maximum allowed winning outcome. Operations may include in response to the total win amount exceeding the maximum allowed, replacing (block 710) the first RTP paytable with a second RTP paytable that is higher than the first RTP paytable on future executions of a future games.

In some embodiments, after determining that the winning amount causes the total win amount to exceed the maximum allowed winning outcome, the processor circuit is further caused to deposit (block 712) max win amount in credit bank window. Some embodiments include replacing the first RTP paytable with the second RTP paytable is for a defined quantity of future games. Some embodiments provide that, after the defined quantity of games with the second RTP paytable, the first RTP paytable resumes play.

In some embodiments, the processor circuit is further caused to replace (block 714) the second RTP paytable with a third RTP paytable that is higher than the second RTP paytable.

Some embodiments include causing replacement of the second RTP paytable for a second quantity of games after a first quantity of games.

Some embodiments provide that after a first quantity of games of play for the second RTP paytable, the game is resumed with the first RTP paytable.

Some embodiments provide that the first RTP paytable includes about a 92% paytable. In some embodiments, the second RTP paytable includes a paytable in range from about 94% to about 97%. In some embodiment, the second RTP paytable is determined based on a random selection of a paytable from a range of RTP payables.

Some embodiments provide that the second RTP paytable includes a duration over one or more days. Some embodiments provide that the second RTP paytable may be used for multiple days, particularly within a given jurisdiction. In some embodiments, a quantity of days selected for the second RTP paytable is based on random selection.

Some embodiments provide that a quantity of games selected to use a modified paytable is defined. In some embodiments, a quantity of games selected using a modified paytable is based on random selection.

In some embodiments provide that a defined quantity of future games is based on how much value was lost due to because it was greater than the maximum allowed winning outcome.

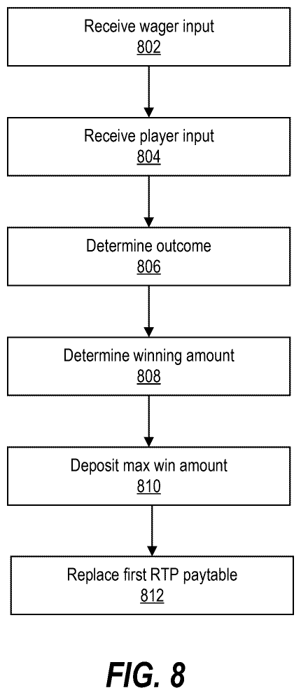

Reference is now made to FIG. 8, which is a flowchart illustrating operations of systems/methods of providing capping handling in a gaming environment, according to some embodiments. An electronic gaming machine (EGM) includes a communication interface in communication with a plurality of gaming devices, a processor circuit and a memory including machine-readable instructions that, when executed by the processor circuit, cause the processor circuit to perform operations including receiving (block 802) a wager input that corresponds to a wager of a game to process on a gaming terminal, receiving (block 804) a player input that causes the gaming terminal to execute the wager. Operations may include determining (block 806) an outcome corresponding to the wager based on a first return to player (RTP) paytable and, based on the outcome corresponding to a winning outcome, determining (block 808) that a winning amount causes a total win amount to exceed a maximum allowed winning outcome. After determining that the winning amount causes the total win amount to exceed the maximum allowed winning outcome, the processor circuit is further caused to deposit (block 810) max win amount in credit bank window. In response to the total win amount exceeding the maximum allowed, operations include replacing (block 812) the first RTP paytable with a second RTP paytable that is higher than the first RTP paytable on future executions of a future games.

Some embodiments provide that, after determining that the winning amount causes the total win amount to exceed the maximum allowed winning outcome, the processor circuit is further caused to deposit a maximum win amount in a credit bank window.

In some embodiments, replacing the first RTP paytable with the second RTP paytable is for a defined quantity of future games, and after the defined quantity of games with the second RTP paytable, the first RTP paytable resumes play.

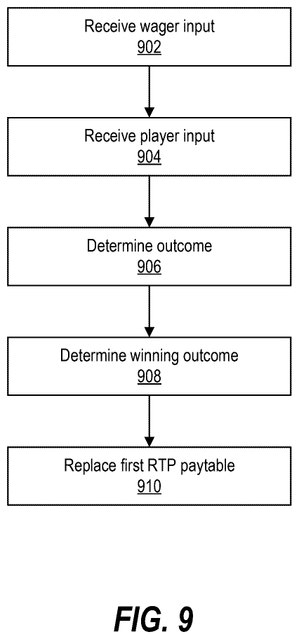

Reference is now made to FIG. 9, which is a flowchart illustrating operations of systems/methods of providing capping handling in a gaming environment, according to some embodiments.

A method may include receiving (block 902) a wager input that corresponds to a wager of a game to process on a gaming terminal and receiving (block 904) a player input that causes the gaming terminal to execute the wager. Operations may include determining (block 906) an outcome corresponding to the wager based on a first return to player (RTP) paytable. Operations may include, based on the outcome corresponding to a winning outcome, determining (block 908) that a winning amount causes a total win amount to exceed a maximum allowed winning outcome. Embodiments include, in response to the total win amount exceeding the maximum allowed, replacing (block 910) the first RTP paytable with a second RTP paytable that is higher than the first RTP paytable on future executions of a future games.

Some embodiments provide that a quantity of days selected for the second RTP paytable is based on random selection, and the quantity of games selected to use a modified paytable is defined.

In some embodiments, a defined quantity of future games is based on how much value was lost due to because it was greater than a maximum allowed winning outcome.

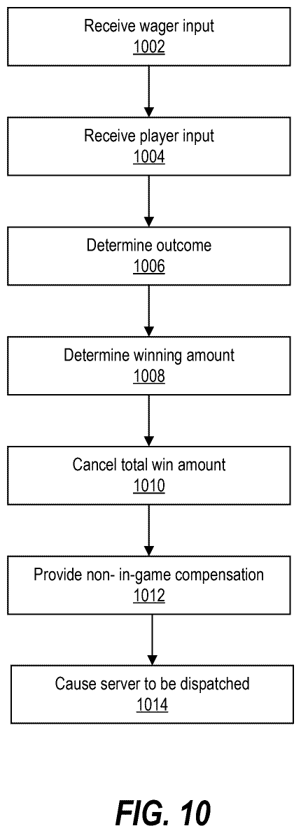

Reference is now made to FIG. 10, which is a flowchart illustrating operations of systems/methods of providing capping handling in a gaming environment, according to some embodiments. A system herein may include a processor circuit and a memory including machine-readable instructions that, when executed by the processor circuit, cause the processor circuit to perform operation herein. Operations include receiving (block 1002) a wager input that corresponds to a wager of a game to process on a gaming terminal, receiving (block 1004) a player input that causes the gaming terminal to execute the wager and determining (block 1006) an outcome corresponding to the wager. Operations may further include, based on the outcome corresponding to a winning outcome, determining (block 1008) that a winning amount causes a total win amount to exceed a maximum allowed winning outcome. Operations include, in response to the total win amount exceeding the maximum allowed winning outcome, cancelling (block 1010) the total win amount that exceeds the maximum allowed winning outcome and providing (block 1012) a non in-game compensation for a canceled winning amount. In some embodiments, a non in-game compensation may refer to a prize and/or value provided outside of a spin in which a capping event may have occurred. In some embodiments, non in-game compensation may refer to awarded merchandise that is not related to the game.

In some embodiments, the maximum allowed winning outcome includes a regulatory requirement imposed by a government entity. In some embodiments, the non in-game compensation comprises quantity of future spins being free to play. In some embodiments, the non in-game compensation includes a quantity of discount future spins discounted based on the canceled winning amount. In some embodiments, the non in-game compensation comprises a comp value that is based on the canceled winning amount.

Some embodiments provide the non in-game compensation includes reduced cost spins that correspond to the canceled winning amount. In some embodiments, the non in-game compensation includes a defined quantity of free spins, and wherein the defined quantity of free spins is based on the canceled winning amount.

In some embodiments, the non in-game compensation includes merchandise that is provided to a player. In some embodiments, the merchandise is based on the canceled winning amount. Some embodiments provide the non in-game compensation includes a discount on merchandise that is available to a player. In some embodiments the non in-game compensation includes a beverage. In some embodiments, in response to canceling the total win amount that exceeds the maximum allowed winning outcome, the operation includes causing (block 1014) a server to be automatically dispatched to engage a player regarding non in-game compensation.

In some embodiments, the non in-game compensation includes a meal and/or meal credit coupon. Some embodiments provide that the non in-game compensation includes a coupon for a casino service. Some embodiments provide that the non in-game compensation includes a bonus game that is different from the game. In some embodiments, the game includes remote gaming and the non in-game compensation is receivable remotely. In some embodiments, the game includes social gaming and the non in-game compensation includes compensation that is redeemable in a social gaming venue. Some embodiments provide that the non in-game compensation includes a contribution to a progressive jackpot.

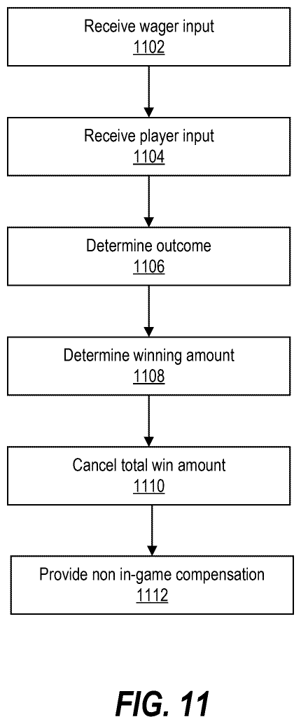

Reference is now made to FIG. 11, which is a flowchart illustrating operations of systems/methods of providing capping handling in a gaming environment, according to some embodiments. An electronic gaming machine (EGM) includes a communication interface in communication with a plurality of gaming devices, a processor circuit, and a memory including machine-readable instructions that, when executed by the processor circuit, cause the processor circuit to perform operations. Operations may include receiving (block 1102) a wager input that corresponds to a wager of a game to process on a gaming terminal and receiving (block 1104) a player input that causes the gaming terminal to execute the wager. Operations include determining (block 1106) an outcome corresponding to the wager and, based on the outcome corresponding to a winning outcome, determining (block 1108) that a winning amount causes a total win amount to exceed a maximum allowed winning outcome. Some embodiments include, in response to the total win amount exceeding the maximum allowed winning outcome, canceling (block 1110) the total win amount that exceeds the maximum allowed winning outcome that corresponds to a regulatory requirement imposed by a government entity. Embodiments may provide (block 1112) a non in-game compensation for a canceled winning amount.

In some embodiments, the non in-game compensation includes quantity of future spins being free to play.

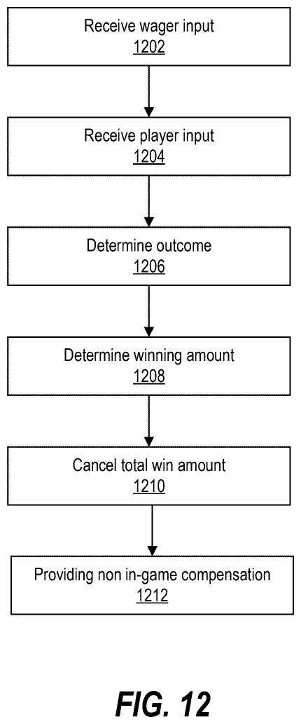

Reference is now made to FIG. 12, which is a flowchart illustrating operations of systems/methods of providing capping handling in a gaming environment, according to some embodiments. Methods herein perform operations including receiving (block 1202) a wager input that corresponds to a wager of a game to process on a gaming terminal and receiving (block 1204) a player input that causes the gaming terminal to execute the wager. Operations include determining (block 1206) an outcome corresponding to the wager and, based on the outcome corresponding to a winning outcome, determining (block 1208) that a winning amount causes a total win amount to exceed a maximum allowed winning outcome. Some embodiments provide that, in response to the total win amount exceeding the maximum allowed winning outcome, canceling (block 1210) the total win amount that exceeds the maximum allowed winning outcome and providing (block 1212) a non in-game compensation for a canceled winning amount.

Embodiments described herein may be implemented in various configurations for gaming devices 100, including but not limited to: (1) a dedicated gaming device, wherein the computerized instructions for controlling any games (which are provided by the gaming device) are provided with the gaming device prior to delivery to a gaming establishment; and (2) a changeable gaming device, where the computerized instructions for controlling any games (which are provided by the gaming device) are downloadable to the gaming device through a data network when the gaming device is in a gaming establishment. In some embodiments, the computerized instructions for controlling any games are executed by at least one central server, central controller or remote host. In such a “thin client” embodiment, the central server remotely controls any games (or other suitable interfaces), and the gaming device is utilized to display such games (or suitable interfaces) and receive one or more inputs or commands from a player. In another embodiment, the computerized instructions for controlling any games are communicated from the central server, central controller or remote host to a gaming device local processor and memory devices. In such a “thick client” embodiment, the gaming device local processor executes the communicated computerized instructions to control any games (or other suitable interfaces) provided to a player.

In some embodiments, a gaming device may be operated by a mobile device, such as a mobile telephone, tablet or other mobile computing device. For example, a mobile device may be communicatively coupled to a gaming device and may include a user interface that receives user inputs that are received to control the gaming device. The user inputs may be received by the gaming device via the mobile device.

In some embodiments, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more gaming devices; and/or (c) one or more personal gaming devices, such as desktop computers, laptop computers, tablet computers or computing devices, PDAs, mobile telephones such as smart phones, and other mobile computing devices.

In certain such embodiments, computerized instructions for controlling any games (such as any primary or base games and/or any secondary or bonus games) displayed by the gaming device are executed by the central server, central controller, or remote host. In such “thin client” embodiments, the central server, central controller, or remote host remotely controls any games (or other suitable interfaces) displayed by the gaming device, and the gaming device is utilized to display such games (or suitable interfaces) and to receive one or more inputs or commands. In other such embodiments, computerized instructions for controlling any games displayed by the gaming device are communicated from the central server, central controller, or remote host to the gaming device and are stored in at least one memory device of the gaming device. In such “thick client” embodiments, the at least one processor of the gaming device executes the computerized instructions to control any games (or other suitable interfaces) displayed by the gaming device.

In some embodiments in which the gaming system includes: (a) a gaming device configured to communicate with a central server, central controller, or remote host through a data network; and/or (b) a plurality of gaming devices configured to communicate with one another through a data network, the data network is an internet or an intranet. In certain such embodiments, an internet browser of the gaming device is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the gaming device, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games and displays those plays via the internet browser of the gaming device.

It should be appreciated that the central server, central controller, or remote host and the gaming device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of gaming devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In some embodiments herein, display devices and/or displays may provide a graphical user interface that may receive input data and/or may display data for one or more users to receive. Some embodiments provide that the graphical user interface may display visual elements that may include symbols, icons, and/or static elements that may be positioned and/or move based on system and/or device data. Some embodiments provide that a processor as provided herein may automatically cause a visual element on the graphical user interface to move, change, or evolve. For example, when a displayed visual element such as an icon is automatically moved, the claim integrates any corresponding mental process into a practical application.

Specifically, embodiments described herein provide elements that recite a specific manner of automatically displaying visual elements, such as icons. Usage as described herein provides improvement over prior systems resulting in an improved user interface for electronic devices.

In the above description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product including one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (“RF”), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, Common Business Oriented Language (“COBOL”) 2002, PHP: Hypertext Processor (“PHP”), Advanced Business Application Programming (“ABAP”), dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (Saas).

In some embodiments herein, display devices and/or displays may provide a graphical user interface that may receive input data and/or may display data for one or more users to receive. Some embodiments provide that the graphical user interface may display visual elements that may include symbols, icons, and/or static elements that may be positioned and/or move based on system and/or device data. Some embodiments provide that a processor as provided herein may automatically cause a visual element on the graphical user interface to move, change, or evolve. For example, when a displayed visual element such as an icon is automatically moved, the claim integrates any corresponding mental process into a practical application.

Specifically, embodiments described herein provide elements that recite a specific manner of automatically displaying visual elements, such as icons. Usage as described herein provides improvement over prior systems resulting in an improved user interface for electronic devices.

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processing circuit of a general purpose computer, special purpose computer, or other programmable data processing apparatus to produce a machine, such that the instructions, which execute via the processing circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

1. A system comprising:
a processor circuit; and
a memory comprising machine-readable instructions that, when executed by the processor circuit, cause the processor circuit to:
receive a wager input that corresponds to a wager of a game to process on a gaming terminal;
receive a player input that causes the gaming terminal to execute the wager;
determine an outcome corresponding to the wager;
based on the outcome corresponding to a winning outcome, determine that a winning amount causes a total win amount to exceed a maximum allowed winning outcome;
in response to the total win amount exceeding the maximum allowed winning outcome,
cancel the total win amount that exceeds the maximum allowed winning outcome; and
provide a non in-game compensation for a canceled winning amount.

2. The system of claim 1, wherein the maximum allowed winning outcome comprises a regulatory requirement imposed by a government entity.

3. The system of claim 1, wherein the non in-game compensation comprises quantity of future spins being free to play.

4. The system of claim 1, wherein the non in-game compensation comprises a quantity of discount future spins discounted based on the canceled winning amount.

5. The system of claim 1, wherein the non in-game compensation comprises a comp value that is based on the canceled winning amount.

6. The system of claim 1, wherein the non in-game compensation comprises reduced cost spins that correspond to the canceled winning amount.

7. The system of claim 1, wherein the non in-game compensation comprises a defined quantity of free spins, and wherein the defined quantity of free spins is based on the canceled winning amount.

8. The system of claim 1, wherein the non in-game compensation comprises merchandise that is provided to a player, wherein the merchandise is based on the canceled winning amount.

9. The system of claim 1, wherein the non in-game compensation comprises a discount on merchandise that is available to a player.

10. The system of claim 1, wherein the non in-game compensation comprises a beverage.

11. The system of claim 10, wherein, in response to canceling the total win amount that exceeds the maximum allowed winning outcome, the processor causes a server to be automatically dispatched to engage a player regarding non in-game compensation.

12. The system of claim 1, wherein the non in-game compensation comprises a meal and/or meal credit coupon.

13. The system of claim 1, wherein the non in-game compensation comprises a coupon for a casino service.

14. The system of claim 1, wherein the non in-game compensation comprises a bonus game that is different from the game.

15. The system of claim 1, wherein the game comprises remote gaming, wherein the non in-game compensation is receivable remotely.

16. The system of claim 1, wherein the game comprises social gaming, and wherein the non in-game compensation comprises compensation that is redeemable in a social gaming venue.

17. The system of claim 1, wherein the non in-game compensation comprises a contribution to a progressive jackpot.

18. An electronic gaming machine (EGM) comprising:
a communication interface in communication with a plurality of gaming devices;
a processor circuit; and
a memory comprising machine-readable instructions that, when executed by the processor circuit, cause the processor circuit to:
receive a wager input that corresponds to a wager of a game to process on a gaming terminal;
receive a player input that causes the gaming terminal to execute the wager;
determine an outcome corresponding to the wager;
based on the outcome corresponding to a winning outcome, determine that a winning amount causes a total win amount to exceed a maximum allowed winning outcome;
in response to the total win amount exceeding the maximum allowed winning outcome, cancel the total win amount that exceeds the maximum allowed winning outcome that corresponds to a regulatory requirement imposed by a government entity; and
provide a non in-game compensation for a canceled winning amount.

19. The EGM of claim 18, wherein the non in-game compensation comprises quantity of future spins being free to play.

20. A method comprising:
receiving a wager input that corresponds to a wager of a game to process on a gaming terminal;
receiving a player input that causes the gaming terminal to execute the wager;
determining an outcome corresponding to the wager;
based on the outcome corresponding to a winning outcome, determining that a winning amount causes a total win amount to exceed a maximum allowed winning outcome;
in response to the total win amount exceeding the maximum allowed winning outcome,
canceling the total win amount that exceeds the maximum allowed winning outcome; and
providing a non in-game compensation for a canceled winning amount.
